(19) United States
(12) Patent Application Publication
(10) Pub. No.: US 2025/0353388 A1
(43) Pub. Date: Nov. 20, 2025

(54) DYNAMIC WIRELESS POWER TRANSFER FOR VEHICLES

(71) Applicant: Cummins Inc., Columbus, IN (US)

(72) Inventors: Hoseinali Borhan, Bloomington, IN (US); John P. Kresse, III, Martinsville, IN (US); J. Steven Kolhouse, Columbus, IN (US); Aleksey Yezerets, Columbus, IN (US)

(73) Assignee: Cummins Inc., Columbus, IN (US)

(21) Appl. No.: 19/288,448

(22) Filed: Aug. 1, 2025

Related U.S. Application Data
(63) Continuation of application No. PCT/US2024/014211, filed on Feb. 2, 2024.
(60) Provisional application No. 63/443,293, filed on Feb. 3, 2023.

(51) Int. Cl. B60L 53/126; B60L 53/62; B60L 53/66; B60L 58/13

(52) U.S. Cl. CPC B60L 53/126; B60L 53/62; B60L 53/66; B60L 58/13; B60L 2240/12; B60L 2240/622; B60L 2240/70

(57) ABSTRACT

Presented herein are systems and methods of modifying vehicle operations to charge electrical components. A computing system having one or more processors coupled with at least one memory is configured to detect a charge pad along a route of a vehicle. The vehicle may have a charge panel configured to accept electrical power from the charge pad to provide to one or more electrical components in the vehicle. The computing system is configured to modify, in accordance with at least one of the plurality of characteristics of the charge pad and the plurality of operational parameters of the vehicle, at least one operation of the vehicle to receive the electrical power from the charge pad.

### CROSS REFERENCES TO RELATED APPLICATIONS

The present application is a bypass continuation of PCT Application No. PCT/US2024/014211, filed Feb. 2, 2024, which claims the benefit of and priority to U.S. Provisional Patent Application No. 63/443,293, titled “Dynamic Wireless Power Transfer for Vehicles,” filed Feb. 3, 2023, all of which are incorporated herein by reference in their entireties and for all purposes.

### TECHNICAL FIELD

The present disclosure relates to power systems. More particularly, the present disclosure relates to systems and methods for dynamic wireless power transfer (DWPT) systems for vehicles.

### BACKGROUND

A vehicle may propel itself to travel along a route on a driving surface from a starting point to a terminal point. As a vehicle travels along the route, various electrical components within the vehicle may consume electrical power. A reduction in power may cause a need for an energy recharge event, such as for a battery or other energy storage device. With at least partially electric vehicles, electrical energy depletion due to accessory usage may cause frequent stop events to enable recharge events. These stops may lead to undesired downtime and other undesired occurrences.

### SUMMARY

At least one aspect of the present disclosure relates to systems for modifying vehicle operations to charge electrical components. The system may include a computing system having one or more processors coupled with at least one memory, configured to: detect a charge pad along a route of a vehicle, the vehicle comprising a charge panel configured to accept electrical power from the charge pad to provide to one or more electrical components in the vehicle; identify, responsive to detection of the charge pad, a plurality of characteristics of the charge pad and a plurality of operational parameters of the vehicle; and modify, in accordance with at least one of the plurality of characteristics of the charge pad or the plurality of operational parameters of the vehicle, at least one operation of the vehicle to receive the electrical power from the charge pad.

In some embodiments, the computing system may modify a speed of the vehicle along the route based on a plurality of characteristics of the charge pad. In some embodiments, the computing system may modify an operation parameter of the charge panel based on a comparison between a current speed of the vehicle with a target speed for the charge transmission panel. In some embodiments, the computing system may modify a position of the charge panel to accept the electrical power from the charge transmission panel along the route. In some embodiments, the computing system may modify a vehicle position along the route to accept the electrical power from the charge transmission panel.

At least one aspect of the present disclosure relates to a method of modifying vehicle operations to charge electrical components. The method may include: detecting, by a computing system, a charge pad along a route of a vehicle, the vehicle comprising a charge panel configured to accept electrical power from the charge pad to provide to one or more electrical components in the vehicle; identifying, by the computing system, responsive to detection of the charge pad, a plurality of characteristics of the charge pad and a plurality of operational parameters of the vehicle; and modifying, by the computing system, at least one operation of the vehicle to receive the electrical power from the charge pad in accordance with at least one of the plurality of characteristics of the charge pad or the plurality of operational parameters of the vehicle.

At least one aspect of the present disclosure relates to a vehicle. The vehicle may include a charge panel structured to be electrically coupled with one or more electrical components; and a controller coupled to the charge panel, the controller having one or more processors coupled with at least one memory, configured to: detect, along a route of the vehicle, a charge pad from which to accept electrical power to provide to the one or more electrical components via the charge panel; identify, responsive to detection of the charge pad, a plurality of characteristics of the charge pad and a plurality of operational parameters of the vehicle; and modify, in accordance with at least one of the plurality of characteristics of the charge pad or the plurality of operational parameters of the vehicle, at least one operation of the vehicle to receive the electrical power from the charge pad.

At least one aspect of the present disclosure relates to a system for controlling a charging of vehicle components. The system may include a first computing system having one or more processors coupled with memory, configured to: identify an absence of a fault in a charge panel of a vehicle; determine that a state of charge (SOC) of the vehicle is below a threshold; and enable, responsive to the identification of the absence of the fault and determination that the SOC of the vehicle is below the threshold, a charge panel of the vehicle to accept electrical power.

At least one aspect of the present disclosure relates to a method of controlling of charging vehicle components. The method may include identifying, by a computing system, an absence of a fault in a charge panel of a vehicle; determining, by the computing system, that a state of charge (SOC) of the vehicle is below a threshold, and enabling, by the computing system, responsive to the identification of the absence of the fault and determination that the SOC of the vehicle is below the threshold, a charge panel of the vehicle to accept electrical power.

In some embodiments, the computing system may enable, responsive to a determination that a value of charging is below a second threshold, the charge panel to accept the electrical power. In some embodiments, the computing system may to enable, responsive to a determination that the SOC is below a critical threshold and a value of charging is above a second threshold, the charge panel to accept the electrical power.

In some embodiments, the computing system may determine, using data acquired via a sensor, a presence of charge pad along a route of the vehicle while the vehicle traveling the route (e.g., while the vehicle is in motion or moving). In some embodiments, the computing system may determine, based on a plurality of characteristics of a charge pad along a route of the vehicle, to convey the electrical power from the charge panel of the vehicle to the charge pad.

In some embodiments, the computing system may determine whether to draw electrical power from one of: a combustion engine on the vehicle or the charge panel. The drawn power may be used to propel the vehicle and/or power one or more electrical accessories (e.g., a heating, ventilation and air conditioning system, power seat controls, display devices, etc.). In some embodiments, the computing system may communicate, responsive to detection of a presence of charge pad along a route of the vehicle, with the charge pad to convey the electrical power. In some embodiments, the computing system may perform a test on at least one of the charge panel of the vehicle or a charge pad along a route of the vehicle, using a predetermined inductive charge for the electrical power.

At least one aspect of the present disclosure relates to a system for providing electrical power. The system may include a first computing device having one or more processors coupled with memory, configured: receive, from a second computing device, a request for a provision of electrical power from a charge pad array to a vehicle; determine, based on the request, an estimated value associated with the provision of the electrical power from the charge pad array; transmit, to the second computing device, a response identifying the estimated value associated with the provision of the electrical power; and activate, responsive to acceptance of the response, one or more of a plurality of charge pads of the charge pad array to provide the electrical power to the vehicle.

At least one aspect of the present disclosure relates to a method of providing electrical power. The method of may include: receiving by a first computing device, from a second computing device, a request for a provision of electrical power from a charge pad array to a vehicle; determining, by the first computing device, based on the request, an estimated value associated with the provision of the electrical power from the charge pad array; transmitting, by the first computing device, to the second computing device, a response identifying the estimated value associated with the provision of the electrical power; and activating, by the first computing device, responsive to acceptance of the response, one or more of a plurality of charge pads of the charge pad array to provide the electrical power to the vehicle.

At least one aspect of the present disclosure relates to a system for requesting a provision of electrical charge. The system may include a first computing device having one or more processors coupled with memory, configured to: transmit, to a second computing device, a request for provision of electrical power from a charge pad array to a vehicle; receive, from the second computing device, a response identifying an estimated value associated with the provision of the electrical power determined based on the request; and activate, responsive to acceptance of the response, a charge panel of the vehicle to receive the electrical power from the charge pad array.

At least one aspect of the present disclosure relates to a method of requesting electrical power. The method of may include: transmitting, by a first computing device, to a second computing device, a request for provision of electrical power from a charge pad array to a vehicle; receiving, by the first computing device, from the second computing device, a response identifying an estimated value associated with the provision of the electrical power determined based on the request; and activating, by the first computing device, responsive to acceptance of the response, a charge panel of the vehicle to receive the electrical power from the charge pad array.

At least one aspect of the present disclosure relates to a system for exchanging electrical power among vehicles. The system may include a first vehicle having a first charge panel disposed along a first side. The system may include a first computing device disposed on the first vehicle having one or more processors coupled with memory, configured to: detect a presence of a second vehicle having a second charge panel disposed along a second side; initiate, responsive to detection of the second vehicle, communications between the first vehicle and the second vehicle to coordinate charging; and activate the first charge panel to transfer electrical power from the first vehicle to the second vehicle via the second charge panel.

At one aspect of the present disclosure relates to a method of exchanging electrical power among vehicles. The method may include detecting, by a first computing device, a presence of a second vehicle having a second charge panel disposed along a second side; initiating, by the first computing device, responsive to detection of the second vehicle, communications between the first vehicle and the second vehicle to coordinate charging; and activating, by the first computing device, the first charge panel to transfer electrical power from the first vehicle to the second vehicle via the second charge panel.

In some embodiments, the charge array may include a plurality of charge transmission panels arranged in a curvature within a driving surface. At least one aspect of the present disclosure is a vehicle. The vehicle may include a charge transmission panel to convey electrical power to another vehicle (or another receptacle, such as panels in or near the road to transmit power to a power grid). The vehicle may include a charge panel to receive electrical power from a charge pad along a route of the vehicle. In some embodiments, the charge transmission panel may be disposed on a first side of the vehicle and the charge panel may be disposed on a second side of the vehicle opposite of the first side.

These and other features, together with the organization and manner of operation thereof, will become apparent from the following detailed description when taken in conjunction with the accompanying drawings. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements unless otherwise indicated, in which:

FIG. 1 depicts a block diagram of a system for managing operations of vehicles to exchange electrical power, in accordance with an illustrative embodiment;

FIG. 2 depicts an aerial view of an environment of vehicles adjusting motion to accept electrical power with charge arrays, in accordance with an illustrative embodiment;

FIG. 3 depicts an aerial view of an environment of vehicles exchanging electrical power with other vehicles, in accordance with an illustrative embodiment;

FIG. 4 depicts an aerial view of an environment of charge arrays arranged to provide electrical power to vehicles, in accordance with an illustrative embodiment;

FIG. 5 depicts a flow diagram of a method of managing charge panels of vehicles to exchange electrical power in accordance with an illustrative embodiment;

FIG. 6 depicts a flow diagram of a method of modifying vehicle operations to charge electrical components in accordance with an illustrative embodiment;

FIG. 7 depicts a flow diagram of a method of providing electrical power from charging infrastructure in accordance with an illustrative embodiment; and

FIG. 8 depicts a flow diagram of a method of exchanging electrical power among vehicles in accordance with an illustrative embodiment.

### DETAILED DESCRIPTION

Following below are more detailed descriptions of various concepts related to, and implementations of, methods, apparatuses, and systems for managing operations of vehicles to exchange electrical power. The various concepts introduced above and discussed in greater detail below may be implemented in any number of ways, as the concepts described are not limited to any particular manner of implementation. Examples of specific implementations and applications are provided primarily for illustrative purposes.

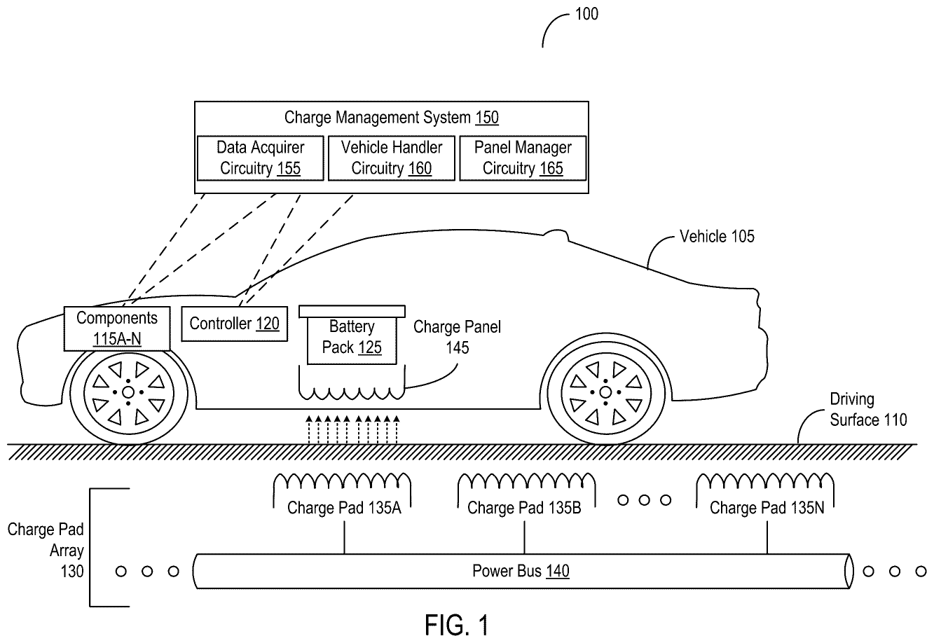

Referring now to FIG. 1, among others, depicted is a block diagram of an environment or a system 100 for managing operations of vehicles to exchange electrical power. The system 100 may include at least one vehicle 105 traveling on a driving surface 110. The vehicle 105 may be an electric vehicle (EV) powered by an internal electrical energy source (e.g., a battery pack) or a hybrid vehicle powered by both an internal combustion engine and the internal electrical energy source, among others. The vehicle 105 may be, for example, a plug-in electric vehicle (EV, electric car, etc.), battery electric vehicle (BEV), fuel cell electric vehicle (FCEV), hybrid electric vehicle (HEV), plug-in hybrid electric vehicle (PHEV), range-extended electric vehicle (REEV), extended-range electric vehicle (E-REV), range-extended battery-electric vehicle (BEVx), or other vehicle powered by or otherwise operable via at least one of a battery, generator (e.g., a power generator, generator plant, electric power strip, on-board rechargeable electricity storage system, etc.), an engine, and a motor, among others. The vehicle 105 may be any type of vehicle, such as an automobile (e.g., a sedan as depicted, a truck, a bus, or a van), a motorcycle, an airplane, a helicopter, a locomotive, or a watercraft, among others. The vehicle 105 may be propelling itself along the driving surface 110 in any type of environment. For example, when the vehicle 105 is an automobile, the driving surface 110 may be a road, an avenue, a highway, a parking lot, or an off-road trail, among others.

The vehicle 105 may house, contain, or otherwise include one or more components 115A-N (hereinafter generally referred to as components 115). The components 115 may control, handle, or provide various functions for the vehicle 105. The functions may include, for example, engine electronics, transmission electronics, chassis electronics, passenger comfort, drive assistance (e.g., advanced drive assistance systems (ADAS)), communications, power steering, braking systems, and entertainment, among others. For example, for the engine electronics, the components 115 can include a motor-generator coupled to or disposed in a power train, drive shaft, axle housing, or wheels, among others, of the vehicle 105. The components 115 can include mechanical components or accessory to the vehicle engine, such as a radiator fan, air compressor, fuel pump, water pump, power steering pumps, and air conditioning system, among others. The components 115 may be electrically or communicatively coupled with one another and other parts of the vehicle 105.

The vehicle 105 may also house, contain, or otherwise include at least one battery pack 125. The battery pack 125 may include one or more batteries configured to store and maintain electrical power received from an electrical power source outside the vehicle 105, such as a charging station and/or inductive charging pads in the environment. The battery pack 125 may be electrically coupled with other parts of the vehicle 105, such as the components 115 and the controller 120, among others. When discharging, the one or more batteries in the battery pack 125 may deliver, supply, or otherwise provide electrical power for the various components 115 of the vehicle 105. When charging, the one or more batteries in the battery pack 125 may receive and accept the electrical energy for storage from an external power source outside the vehicle 105. For instance, the battery pack 125 may be charged from a grid power source, such as via high power direct current (DC) charging from roof mounted rails via a pantograph, high power DC charging from a plug on side of the vehicle, or alternating-current (AC) charging from plug on side of vehicle (e.g., for overnight charging, among others.

The vehicle 105 may house, contain, or otherwise include at least one controller 120. The controller 120 (sometimes herein referred to as a computing system or a computing device) may be disposed in at least one electronic control unit (ECU). The controller 120 may be communicatively coupled with various components in the vehicle 105, such as an internal combustion engine, an electric motor, the battery pack 125, an exhaust aftertreatment system, a power train, a transmission control unit, among others. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a CAN bus provides the exchange of signals, information, and/or data. The CAN bus includes any number of wired and wireless connections.

Because the controller 120 is communicably coupled to the systems and components in the vehicle 105, the controller 120 may be structured to receive data (e.g., instructions, commands, signals, values, etc.) from one or more of the components of the vehicle 105. This may generally be referred to as internal vehicle information (e.g., data, values, etc.). The internal vehicle information represents determined, acquired, predicted, estimated, and/or gathered data regarding one or more components in vehicle 105. The controller 120 may be part of one or more electronic control units (may be included with or separate from an engine control module/unit, a transmission control unit, a battery management system, etc.) to control and regulate various operations of one or more systems or devices of the vehicle 105. The controller 120 may include one or more processing circuits having one or more processors coupled to one or more memory unit. The at least one processor and memory units of the controller 120 may be structured or configured to execute or implement the instructions, commands, and/or control processes described herein.

The system 100 may include at least one charge pad array 130. The charge pad array 130 may transfer, convey, or exchange electrical power with the vehicle 105 traveling along the driving surface 110. The charge pad array 130 may be disposed, arranged, or otherwise situated on, about, or within the driving surface 110. In some embodiments, the charge pad array 130 may be installed or arranged within the driving surface 110. For example, as depicted, the charge pad array 130 may be buried and installed within the driving surface 110 and at least partly below the pavement of the road. In some embodiments, the charge pad array 130 may be installed or disposed upon the driving surface 110. For instance, the charge pad array 130 may be attached to a side of a barrier or a fence along the road corresponding to the driving surface 110. For example, the charge pad array or at least some of the charging pads may be installed in a shoulder of the road. As another example, the charge pad array or at least some of the charging pads may be installed in a rail, guard, or barrier disposed on the side of the road. As still another example, a combination of placing the charge pad array in the shoulder of the road, a rail or guard on the side of the road, and in the road (e.g., in a traffic lane) may be implemented with the system. Beneficially, by installing the charge pad array away from the driving surface, maintenance or other service activities of the charge pad array 130 may not cause roadway shutdowns. Rather, this side offset placement enables maintenance or other service activities to occur without or likely without causing a lane or road shutdown.

The charge pad array 130 may include a set of charge pads 135A-N (hereinafter generally referred to as charge pads 135) and at least one power bus 140. Through the charge pads 135 and the power bus 140, the charge pad array 130 may provide high power direct current (DC) charging, low power DC charging, high power AC charging, and low power AC charging, among others. The power bus 140 may be structured to be electrically coupled with the set of charge pads 135 in any configuration, such as in parallel (e.g., as depicted) or in series, or any combination thereof. The power bus 140 may carry, transfer, or otherwise exchange electrical power to and from the charge pads 135. The power bus 140 may be comprised of an electrical cable to carry the electrical power, such as a coaxial cable, a twisted pair cable, ribbon cable, or multicore cable, among others. When discharging, the power bus 140 may send, relay, or otherwise provide the electrical power from a power source (e.g., a base station) to the charge pads 135. When charging, the power bus 140 may obtain, receive, or otherwise accept the electrical power from the charge pads 135 to a power load (e.g., a battery pack) at the base station.

In the charge pad array 130, each charge pad 135 may wirelessly exchange the electrical power with a component electrically coupled thereto. The wireless exchange of the electrical power may be in accordance with inductive coupling, resonant inductive coupling, magnetodynamic coupling, or capacitive coupling, among others. For instance, under inductive coupling, the charge pad 135 and the other coupled component may each be an electrically conductive coil (e.g., a coil of wires) to transfer the electrical field via a magnetic field formed between the charge pad 135 and the component. The charge pad 135 may operate as a receiver or a transmitter of the electrical power. When discharging, the charge pad 135 may wirelessly relay, send, or otherwise provide the electrical power to the coupled component. Conversely, when charging, the charge pad 135 may wirelessly obtain, receive, or otherwise accept the electrical power from the coupled component.

The vehicle 105 may include at least one charge panel 145 structured or configured to wirelessly exchange electrical power with a component electrically coupled thereto. The charge panel 145 may include, for example, include conductive coil (e.g., a coil of wires) to transfer the electrical field via a magnetic field formed between another component (e.g., the charge pad 135) and the charge panel 145 itself. In some embodiments, the charge panel 145 may be arranged, disposed, or otherwise situated on a longitudinal side of the vehicle 105. For instance, as depicted, the charge panel 145 may be installed on the underside of the vehicle 105 and may span longitudinally facing the driving surface 110. In some embodiments, the charge panel 145 may be arranged, disposed, or otherwise situated on a lateral side of the vehicle 105. For example, the charge panel 145 may be installed within the doors of the vehicle 105, and may span relatively vertically from the driving surface.

The charge panel 145 may transfer or exchange the electrical power with one or more charge pads 135 of the charge pad array 130. As the vehicle 105 travels along the driving surface 110, the charge panel 145 may become positioned or situated relative to (e.g., above) the charge pads 135 of the charge pad array 130. When positioned in this manner, the charge panel 145 may become inductively coupled with the charge pad 135. Through the inductive coupling, the charge panel 145 and the charge pad 135 may exchange the electrical power, and the charge panel 145 may operate as a receiver or a transmitter of the electrical power. When charging (e.g., as depicted), the charge panel 145 may wirelessly obtain, receive, or otherwise accept the electrical power from the charge pad 135. Upon acceptance, the charge panel 145 may supply, deliver, or provide at least a portion of the electrical power to the components 115. For instance, the charge panel 145 may deliver the electrical power to the power train and other mechanical accessories for the vehicle engine. In some embodiments, the charge panel 145 may provide at least a portion of the electrical power to the battery pack 125 for storage. In some embodiments, the charge panel 145 may provide the electrical power to both the components 115 and the battery pack 125. Conversely, when discharging, the charge panel 145 may wirelessly send, convey, or otherwise provide the electrical power to the charge pad 135. To provide, the charge panel 145 may transfer, carry, or otherwise draw the electrical power from the battery pack 125.

The system 100 may include at least one charge management system 150 (sometimes herein generically referred to as a charge management computing system). The charge management system 150 may include at least one data acquirer circuitry 155, at least one vehicle handler circuitry 160, and at least one panel manager circuitry 165, among others. In brief overview, the charge management system 150 may handle, manage, or other control the transfer of electrical power via the charge panel 145 in the vehicle 105. The data acquirer circuitry 155 may identify information associated with the vehicle 105. The vehicle handler circuitry 160 may adjust various operations of the vehicle 105 to optimize charging via the charge panel 145. The panel manager circuitry 165 may configure the charge panel 145.

The charge management system 150 may be executed using various circuitry (e.g., hardware or a combination of hardware and software) within the system 100. In some embodiments, the charge management system 150 may be a part of one or more of the components 115 or of the controller 120 in the vehicle 105 (e.g., as depicted). In some embodiments, the charge management system 150 may be a part of remote computing system in communication with the vehicle 105. The remote computing system may be maintained, operated by, or otherwise associated with an entity, such as an original equipment manufacturer (OEM), a service provider (e.g., a fleet manager), an analytics provider, or an insurance provider, among others, or any combination thereof. In some embodiments, the functionalities of the charge management system 150 may be distributed across the one or more components 115 and the controller 120 of the vehicle 105 and the remote computing system in communication with the vehicle 105.

The charge management system 150 (and its components such as the data acquirer circuitry 155, the vehicle handler circuitry 160, and the panel manager circuitry 165) may be implemented using circuitry. The circuitry can include logic or machine-readable instructions to define the behavior, functions, and operations of the charge management system 150. The circuitry may include computer readable media which may include code written in any programming language including, but not limited to, Java, JavaScript, Python or the like and any conventional procedural programming languages, such as the “C” programming language or similar programming languages

The one or more processors in the charge management system 150 can communicate with one or more remote processors. The remote processors may be connected to each other through any type of network (e.g., a CAN bus, etc.). The memory (e.g., RAM, ROM, Flash Memory, hard disk storage, etc.) may be a computer-readable medium to store data or computer code for facilitating the various processes described herein. The memory may be communicably connected to the processing circuitry to provide computer code or instructions for executing at least some of the processes described herein. The memory may be or include tangible, non-transient volatile memory or non-volatile memory and may include database components, object code components, script components, or any other type of information structure for supporting the various activities and information structures described herein.

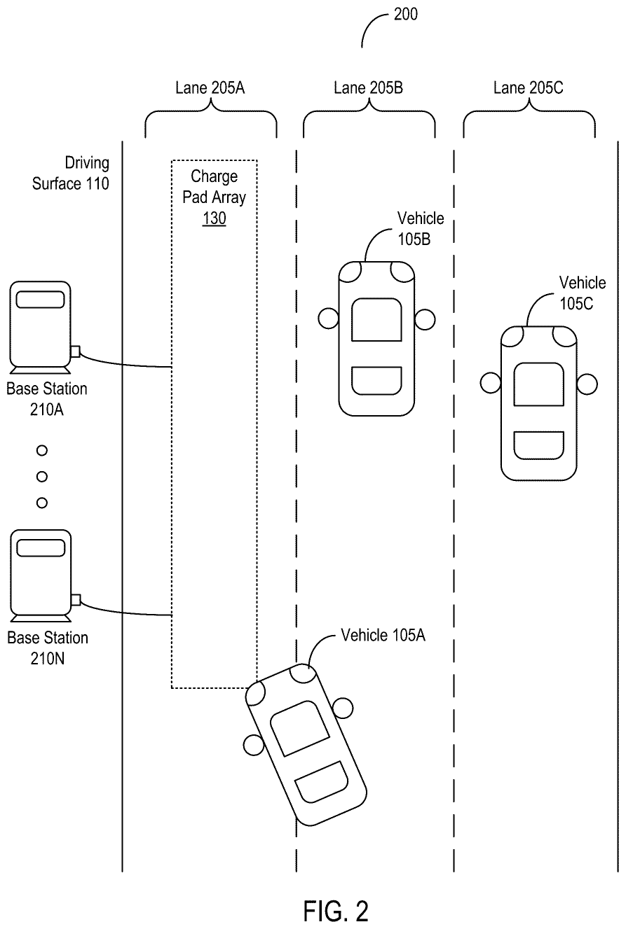

Referring now to FIG. 2, among others, depicted is an aerial view of an environment 200 of vehicles adjusting motion to accept electrical power with charge arrays. The environment 200 may include one or more of the components as discussed in the system 100 above. In addition, the driving surface 110 of the environment 200 may include a route along which the vehicle 105 is traveling. The driving surface 110 may include a set of lanes 205A-C (hereinafter generally referred as lanes 205). The lanes 205 may correspond to respective sections of the driving surface 110 (e.g., a highway as depicted) along which the vehicles 105A-C (hereinafter generally referred to as vehicles 105) travel. At least partly within at least one of the lanes 205A, the charge pad array 130 may be arranged or installed. The charge pad array 130 may be electrically coupled with one or more base stations 210A-N (hereinafter generally referred to as base stations 210). Each base station 210 may be a power source (e.g., a power generator or battery pack) to supply and deliver electrical power to the charge pads 135 of the charge pad array 130 via the power bus 140.

In context, the data acquirer circuitry 155 executing on the charge management system 150 may monitor for the charge pad array 130 (or the charge pad 135) along the route of a respective vehicle 105. The route may correspond to at least a portion of the driving surface 110, such as the lanes 205 on the road, along which the vehicle 105 is traveling. To detect, the data acquirer circuitry 155 may identify a geographic location (e.g., via a global positioning system GPS coordinate) and a direction of travel of the vehicle 105 (e.g., based on repeated GPS coordinates that indicate a direction and/or via a user input and/or via another methodology).

The data acquirer circuitry 155 may check the geographic location and the direction of travel against the map data for the environment 200. The data acquirer circuitry 155 may access map data identifying one or more features in the environment 100 through which the vehicle 105 is traveling. For example, the map data may define, identify, or otherwise include geographical information for the features (e.g., roads, highways, parking lots, buildings, rivers, mountains, towns, cities, and other geographic objects) in the environment 100 in a structured format, such as with points, vectors, or polygons, among others. The map data may be accessible via a remote map service provider or may be stored and maintained on a local database of the charge management system 150. Using the map data, the data acquirer circuitry 155 may determine whether the charge pad array 130 exists within a set distance from the vehicle 105 along the direction of travel. When the charge pad array 130 exists, the data acquirer circuitry 155 may detect the presence of the charge pad array 130. Otherwise, when the charge pad array 130 does not exist, the data acquirer circuitry 155 may determine that there is no charge pad array 130.

In some embodiments, the data acquirer circuitry 155 may use data acquired via a sensor of the vehicle 105 to determine or detect the presence of the charge pad array 130 along the route of the vehicle 105. The sensor may include, for example, a vehicle radar, Lidar, or camera, among others. For instance, the data acquired by the sensor may be an image of signage along the highway corresponding to the route. The signage may contain text identifying the existence of the charge pad array 130 within a set distance. Using computer vision (e.g., optical character recognition (OCR)), the data acquirer circuitry 155 may recognize the text. With the identification of the text, the data acquirer circuitry 155 may use natural language processing (NLP) techniques (e.g., knowledge graph) to determine whether the text is for the charge pad array 130. When determined to be for charge pad array 130, the data acquirer circuitry 155 may detect the presence of the charge pad array 130. Otherwise, when the text is determined to be not for the charge pad array 130, the data acquirer circuitry 155 may determine that there is no charge pad array 130.

With the detection of the charge pad array 130, the data acquirer circuitry 155 may acquire, retrieve, or otherwise identify a set of characteristics of the charge pad array 130 (or the charge pad 135). The characteristics of the charge pad array 130 may identify or include, for example, charging locations (e.g., for individual charge pads 135), a charger type, a charge availability (or vacancy or occupation state), a charging power level (e.g., high-power or low-power), a charging rate (e.g., fast or slow rate), a charging cost, and a charging power source (e.g., non-renewable or fossil fuel), among others. In addition, the data acquirer circuitry 155 may acquire, retrieve, or otherwise identify a set of operational parameters for the vehicle 105 traveling on the route. The parameters for the vehicle 105 may identify or include, for example, a state of charge (SOC) (e.g., of the battery pack 125), a battery age (e.g., of the battery pack 125), a remaining range of the vehicle 105, a speed, a direction of travel, travel time, and a traffic status, among others. The SOC may identify charge level of the battery, such as the current battery capacity versus the maximum battery capacity, measured as a percentage. The battery capacity may identify an amount of charge the battery pack 125 can deliver within a specific amount of time, measured for example in ampere-hours.

The vehicle handler circuitry 160 executing on the charge management system 150 (or independently) may configure, set, or otherwise modify at least one operation of the vehicle 105. In some embodiments, the vehicle handler circuitry 160 may determine whether to adjust or modify the route along which the vehicle 105 is traveling based on one more parameters or characteristics of the charge pad array 130. The modification of the route may include a change from one lane 205 to another lane 205, an instruction to take a different route to encounter the charge pad array 130, and/or a combination thereof. For example, when the charge pad array 130 is determined to be available, the vehicle handler circuitry 160 may determine to modify the route to cause the vehicle to move toward the charge pad array 130. As a specific example, the vehicle may be travelling in the middle lane of three-lane highway. The charge pad array 130 may be determined to be along the right-side of the road in an upcoming distance. The vehicle handler circuitry 160 may provide an instruction (e.g., via a user interface on the vehicle) to move the vehicle into the right lane to enable the vehicle to receive a wireless charge while the vehicle is moving (i.e., a dynamic wireless charging event). When the charge pad array 130 is determined to not be available, the vehicle handler circuitry 160 may determine whether a wait time until availability is within a threshold time limit. If within the threshold time limit, the vehicle handler circuitry 160 may modify the route of the vehicle 105 to move toward the charge pad array 130. For instance, using map data, the vehicle handler circuitry 160 may generate a new route to take the vehicle 105 through a new road to arrive at the charge pad array 130. Otherwise, if outside the threshold time limit, the vehicle handler circuitry 160 may maintain the route of the vehicle 105.

In some embodiments, the vehicle handler circuitry 160 may set, adjust, or otherwise modify the speed of the vehicle 105 based on the set of characteristics of the charge pad array 130 or the operational parameters of the vehicle 105, or both (e.g., via at least partial automatic driving of the vehicle via ADAS, such as changing the speed of the vehicle during an adaptive cruise control operating mode and changing lanes for the vehicle during at least partial autonomous driving). For instance, the vehicle handler circuitry 160 may calculate or determine the speed for the vehicle 105 to achieve a target state of charge (SOC) for the battery pack 125 of the vehicle 105 via the charge panel 145 based on the charging rate of the charge pad array 130. In some embodiments, the vehicle handler circuitry 160 may determine to set, adjust, or otherwise modify the speed of the vehicle 105 to a target speed to optimize acceptance of the electrical power via the charge panel 145. For example, the vehicle handler circuitry 160 may calculate or determine the target speed for optimal charging in accordance with a function of the characteristics of the charge pad array 130 and the operational parameters of the vehicle 105.

In some embodiments, the vehicle handler circuitry 160 may set, adjust, or otherwise modify the charging system parameters identifying operations of the charge panel 145 based on the measured speed of the vehicle 105 along the route relative to the target speed for predefined optimal charging. The charging system parameters may identify or include, for example, charging power (e.g., coil energizing), number of receiver plates (e.g., in the charge panel 145) activated or deactivated, and adjustment of air gap within the charge panels 145, among others. In some embodiments, the vehicle handler circuitry 160 may modify the charging system parameters for the charge panel 145 based on fault information on the charge panel 145 or individual charge pads 135 in the charge pad array 130 (e.g., within the road or on the side of the road). The adjustment of the operations of the charge panel 145 may be based on a comparison of the measured speed and the initially determined target speed.

In some embodiments, the vehicle handler circuitry 160 may set, adjust, or otherwise modify a positioning of the charge panel 145 (or the vehicle 105 itself) to optimize or attempt to optimize delivery of the electrical power from the charge pad 135 of the charge pad array 130. The positioning may include, for example, a height of the charge panel 145 (or the underside of the vehicle 105) relative to the driving surface 110 (or the charge pad 135), a location of the charge panel 145 on the vehicle 105 (e.g., moving left or right relative to the direction of travel of the vehicle 105), or an orientation (or angle) of the charge panel 145 itself relative to the driving surface 110 (or the charge pad 135), among others. The positioning may be determined based on a function of the set of characteristics of the charge pad array 130 or the operational parameters of the vehicle 105, or both. The efficiency of the charging may be based on the positioning of the charge panel 145 relative to the charge pad 135.

To adjust the positioning of the charge panel 145, the vehicle handler circuitry 160 may transmit, send, or otherwise provide one or more command signals to the charge panel 145 or components coupled with the charge panel 145. The command signals may define an adjustment of the positioning of a respective charge panel 145 by degrees of freedom (e.g., in terms of x-y-z axis or pitch, roll, and yaw axes). For example, the vehicle handler circuitry 160 executing on the controller 120 may send a signal to one or more actuators (e.g., linear actuators or hydraulic actuator) coupled with the charge panel 145 to move the charge panel 145 laterally (e.g., side to side), longitudinally (e.g., up or down), or rotationally (e.g., around an axis defined through the vehicle 105). The vehicle handler circuitry 160 may send the signal to move the charge panel 145 to protrude from the vehicle 105 (e.g., from the side). The vehicle handler circuitry 160 may provide the signal to rotate the charge panel 145 about an axis through the vehicle 105. The vehicle handler circuitry 160 may provide the signal to move the charge panel 145 relative to the charge pad array 130 beneath or along the side (e.g., attached to the railing) of the driving surface 110.

In some embodiments, the vehicle handler circuitry 160 may determine to set, adjust, or otherwise modify a position of the vehicle 105 along the route to accept the electrical power from the charge pad 135 of the charge pad array 130. The position may correspond to which lane 205 the vehicle 105 is on along the driving surface 110 to move the vehicle 105 toward the charge pad array 130. The determination of whether to modify the position may be based on a based on a function of the set of characteristics of the charge pad array 130 or the operational parameters of the vehicle 105, or both. For instance, the vehicle handler circuitry 160 may determine to change from one lane 205B to another lane 205A based on dynamic traffic conditions (e.g., presence of vehicles 105 on the driving surface 110), weather conditions, and obstacles on the road (e.g., a tree fallen down on the road), among others.

If the position is determined to be moved, the vehicle handler circuitry 160 may modify the position of the vehicle 105 to move toward the charge pad array 130. As depicted, the vehicle handler circuitry 160 may modify the route of the vehicle 105A to move from the second lane 205B to the first lane 205A with the charge pad array 130. The vehicle handler circuitry 160 may interface with an autonomous driving or an advanced drive assistance system (ADAS) to effectuate the change in the lanes 205. The autonomous driving system or ADAS may use data on the vehicle 105 to optimize vehicle speed, vehicle position, as well as separation gap between the charge panel 145 in the vehicle 105 and the charge pads 135 of the charge pad array 130. The ADAS may also monitor for presence of vehicles 105 on adjacent lanes 205 when the vehicle 105 is to change from one lane 205 (e.g., lane 205B) to the target lane 205 (e.g., lane 205A). As the vehicle 105 moves onto the lane 205 (e.g., lane 205A) and onto the portion of the lane 205 with the charge pad array 130, the charge panel 145 of the vehicle 105 may start receiving power from the charge pads 135 underneath. Upon receipt, the charge panel 145 may transfer at least a portion of the power to the other components 115 as well as to charge the battery pack 125, all while the vehicle 105 is moving along the lane 205. Otherwise, the vehicle handler circuitry 160 may maintain the position of the vehicle 105 along the route.

In some embodiments, the vehicle handler circuitry 160 may provide information for the operation to be modified to an operator (e.g., a driver) of the vehicle 105. For example, rather than automatically adjusting or modify the operations of the vehicle 105 as discussed above, the vehicle handler circuitry 160 may output or provide information for the operator. The information may be presented a display, such as heads-up display or on the dashboard within the passenger compartment of the vehicle 105. The information may also be relayed to a user in a branch office or an administration center, and then communicated by the user to the operator of the vehicle 105 via mobile phone or radio.

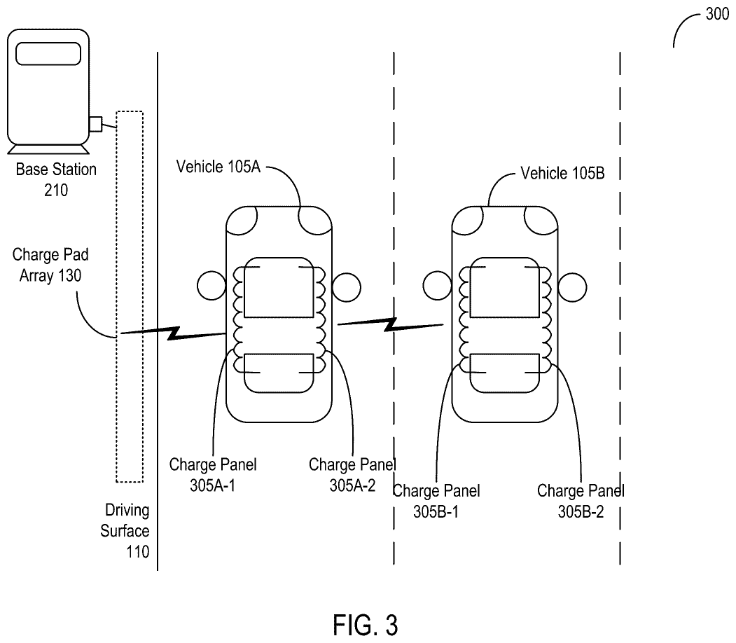

Referring now to FIG. 3, depicted is an aerial view of an environment 300 of vehicles exchanging electrical power with other vehicles. The environment 300 may include one or more of the components as discussed in the system 100 or the environment 200 above. In the depicted example, the environment 300 may include the driving surface 110, such as a parking lot or a road. On the driving surface 110, the environment 300 may include one or more vehicles 10 (e.g., vehicles 105A and 105B). Each vehicle 105 may be located, positioned, or otherwise situated relative to one another. The first vehicle 105A may be situated adjacent to the second vehicle 105B at a distance (e.g., between 0.25 m to 10 m) in a substantially parallel manner (e.g., within 80% of) 180°. The vehicles 105 may be stationary (e.g., when parked in a parking lot) or may be moving (e.g., when traveling on the road) on the driving surface 110.

The charge pad array 130 may be disposed, arranged, or otherwise situated about the driving surface 110, upon which one or more vehicles 105 may be present. For instance, the charge pad array 130 may be installed along a fence adjacent to a parking lot in which one or more vehicles 105 are parked or a road in which the vehicles 105 are moving. The placement of the charge pad array 130 along the side of the road may reduce downtime incurred from buried installation of the charge pad array 130 within the road. When maintenance is to be performed, the charge pad array 130 may be serviced without or with minimal interference to vehicle traffic on the road, allowing vehicles 105 to move relatively freely. In some embodiments, the charge pad array 130 may be disposed, arranged, or otherwise situated within the driving surface 110, such as buried under the road corresponding to the driving surface 110 as depicted in the environment 200. The charge pad array 130 may be electrically coupled with at least one base station 210 to obtain, receive, or otherwise accept the electrical power.

Each vehicle 105 may include a set of charge panels 305A-1 to 305B-2 (hereinafter generally referred to as charge panels 305). The charge panels 305 may be an instance of the charge panel 145 described above, and may be arranged, disposed, or otherwise situated on a lateral side of the respective vehicle 105 (e.g., on a left side and a right side). Within each vehicle 105, the set of charge panel 305 may be electrically coupled with another other to transfer or convey electrical power. In the depicted example, the first vehicle 105A may include a first charge panel 305A-1 along the left side and a second charge panel 305A-2 along the right side. The second vehicle 105B may include a first charge panel 305B-1 along the left side and a second charge panel 305B-2 along the right side. Installed along the lateral sides of the respective vehicles 105, the charge panels 305 may transfer or exchange electrical power via the lateral sides of the vehicles 105 in accordance with inductive charging techniques as discussed above. In some embodiments, the vehicles 105 may transfer or exchange electrical power among themselves, without any one of the vehicles 105 being electrically coupled with the charge pad array 130.

In the environment 300, the charge panels 305 of the first vehicle 105A may provide at least a portion of the electrical power from the charge pad array 130 to the charge panels 305 of the second vehicle 105B. The first vehicle 105A may initiate and coordinate charging with the charge pad array 130 using vehicle-to-everything (V2X) communication protocols. The first vehicle 105A may initiate and coordinate charging with the second vehicle 105B using vehicle-to-vehicle (V2V) communication protocols. The first charge panel 305A-1 of the first vehicle 105A along the left side may obtain, receive, or otherwise accept the electrical power from the charge pad array 130 on the side of the driving surface 110. Upon receipt, the first charge panel 305A-1 may provide the electrical power to the battery pack 125 (one or more batteries or other electrical storage devices) for storage and may transfer the electrical power to the second charge panel 305A-2 of the first vehicle 105A along the right side. Continuing on, the second charge panel 305A-2 of the first vehicle 105A along the right side may transfer or provide the electrical power to the first charge panel 305B-1 of the second vehicle 105B along the left side. Upon receipt, the first charge panel 305B-1 may provide electrical power to the components 115 for consumption and the battery pack 125 for storage within the second vehicle 105B. The transfer of the electrical power between the vehicles 105 may be performed while the vehicles 105 are moving along the driving surface 110 or while stationary.

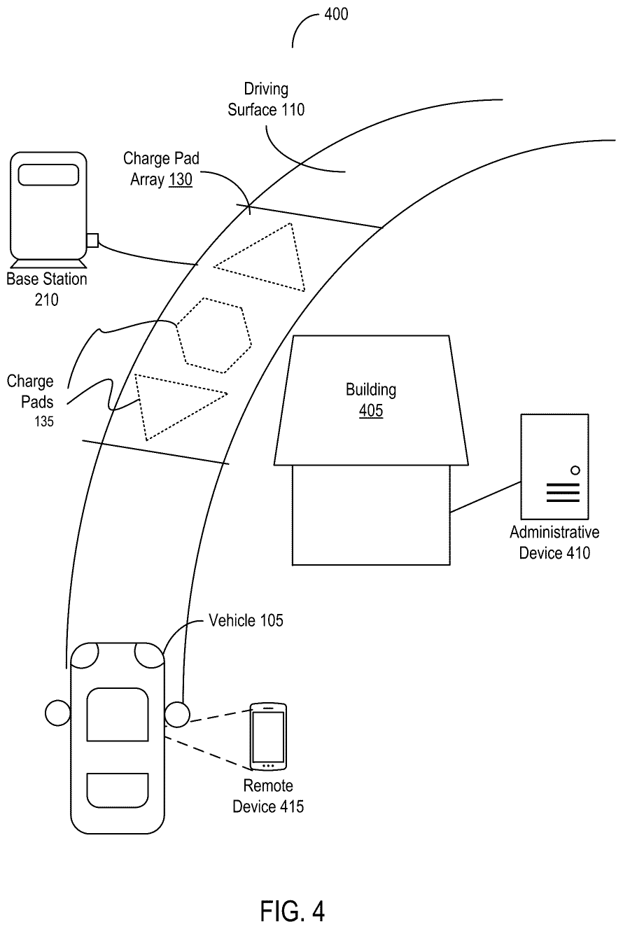

Referring now to FIG. 4, depicted is an aerial view of a system or an environment 400 of charge arrays arranged to provide electrical power to vehicles. The environment 400 may include one or more of the components as discussed in the system 100 or the environments 200 or 300 as detailed herein above. In the environment 400, the driving surface 110 may correspond to a road with a curvature relative to at least one building 405. The set of charge pads 135 of the charge pad array 130 may be disposed, situated, or otherwise arranged in a curvature along with the driving surface 110. Each charge pad 135 may be shaped to conform with the curvature of the driving surface 110. For example, in the charge pad array 130, each charge pad 135 may have a curved, non-rectangular, or any other myriad of shapes to match or substantially match a curvature of the road (e.g., an elongated shape with a curvature). Each charge pad 135 may be of any dimension, with width, length, or diameter ranging between 10 cm to 30 m. This shape may help promote better wireless charging (i.e., via a relatively higher surface area-to-vehicle interface area). As the vehicle 105 travels along the curvature of the road, the charge panel 145 of the vehicle 105 may receive the electrical power from the charge pads 135 of the charge pad array 130 installed within the driving surface 110. In some embodiments, the charge pad array 130 may be disposed, arranged, or otherwise situated adjacent to the driving surface 110 in a curvature. For example, the charge pad array 130 may be positioned above the road and attached to a fence along the side of the road forming a curvature.

In the environment 400, the wireless charging infrastructure (e.g., the charge pad array 130) may be incorporated or integrated with the driving surface 110 associated with an entity of the building 405. For example, the entity of the building 405 may be a residential and/or commercial business or establishment (e.g., a goods store, restaurant, or café). In which case, the driving surface 110 may correspond to a drive-through or a parking area of the building 405 (for commercial establishments) and a driveway with a parking area (in some instances) for residential areas. In the case of a drive-through, the charge pads 135 of the charge pad array 130 may be of a non-rectangular shape to accommodate the curvature of the driving surface 110. Furthermore, the business may supply the charging infrastructure via the grid or on-site power generation equipment capable of delivering renewable or non-renewable energy to the charging infrastructure. With this setup, the entity associated with the building 405 may allow for delivery (e.g., in a complimentary manner or via sale) of the electrical power as the vehicle 105 passes through the driving surface 110 adjacent to the building 405.

Furthermore, the environment 400 may include at least one administrative device 410 associated with owner and/or operator of the building 405. The administrative device 410 may be any computing device including one or more processors and memory unit. The processor and memory unit of the administrative device 410 may be structured or configured to execute or implement the instructions, commands, and/or control processes described herein (e.g., smartphone, tablet computer, desktop computer, wearable computer, etc.). The administrative device 410 may be physically present within the building 405 (e.g., as a point of sale (POS) device) or may be remotely located and in communication with a computing device within the building 405. The administrative device 410 may administer, handle, or otherwise manage the charging infrastructure of the building 405, including the charge pad array 130 and the base station 210. The administrative device 410 may be communicatively coupled with the charging infrastructure and with the vehicle 105 (e.g., using vehicle-to-everything (V2X) communication protocol).

In addition, the environment 400 may also include at least one remote device 415 associated with an operator or passenger of the vehicle 105. The remote device 415 may be any computing device including one or more processors and memory unit. The processor and memory unit of the remote device 415 may be structured or configured to execute or implement the instructions, commands, and/or control processes described herein (e.g., smartphone, tablet computer, desktop computer, wearable computer, etc.). The remote device 415 may be physically present with the passenger of the vehicle 105 or may be a part of the dashboard of the vehicle 105. The remote device 415 may be communicatively coupled with the vehicle 105 (e.g., using vehicle-to-everything (V2X) communication protocol) or the administrative device 410 (e.g., via a public network). The remote device 415 may be installed or may run an application thereon to facilitate communications with the administrative device 410 or a computing system associated with the entity of the building 405. For instance, the application may be a mobile app for placing purchase orders of items (e.g., goods or items), services, or electrical power from the charge pad array 130, among others.

The administrative device 410 may monitor, acquire, or otherwise identify data regarding the operations of the charge pad array 130. In some embodiments, using the data, the administrative device 410 may determine whether each charge pad 135 is properly operating. The administrative device 410 may use the data to perform automated diagnostics and support for the charge pad array 130. For example, the administrative device 410 may detect the presence of a fault in the charge pad array 130 based on receipt of a fault code or error indication that identify malfunctioning charge pads 135 in the charge pad array 130. The administrative device 410 may monitor for periodic heartbeat message signals from the respective charge pads 135 to determine whether the operational status of the charge pads 135 in the charge pad array 130 as operational or non-operational. For instance, the lack of the heartbeat message after a set time period may indicate that the corresponding charge pad 135 is no longer operational.

Continuing on, the administrative device 410 may detect faults when attempting to operate the charge pads 135 in the charge pad array 130 using the monitored data. For instance, after sending command signals to control the operations of the charge pads 135 to move to an optimal position, the administrative device 410 may receive a fault indicator from one of the charge pads 135. Based on the receipt of the indicator, the administrative device 410 may identify an inability to control with at least one of the charge pads 135. In another example, when providing electrical power to the vehicle 105, the administrative device 410 may receive a measurement of power delivered from the vehicle 105 or from the individual charge pad 135. For each charge pad 135, the administrative device 410 may compare the measured power with a threshold to determine whether the health state of the charge pad 135. The threshold may define a value for the measured electrical power (e.g., charge rate or charge amount) at which the charge pad 135 is determined to be a healthy or non-healthy state. When the measured power delivered to the vehicle 105 is below the threshold for the charge pad 135, the administrative device 410 may determine that the charge pad 135 is of the non-healthy state.

Using the data, the administrative device 410 may configure, set, or otherwise modify operations of the charge pad array 130. For example, the administrative device 410 may determine that a subset of charge pads 135 within the charge pad array 130 are non-operational or otherwise disabled. Based on the determination, the administrative device 410 may provide a command signal to disconnect the subset of charge pads 135. The administrative device 410 may also provide a command signal to increase power throughput in a remaining subset of charge pads 135 that are properly operating within the charge pad array 130. When charging the vehicle 105, the administrative device 410 may use the data to coordinate sending of commands signals to deactivate or activate the charge pads 135, such that the charge pads 135 are activated along with the movement of the vehicle 105.

The administrative device 410 and the remote device 415 may communicate with each other to facilitate, handle, or manage transfer of electrical power between the charge pad array 130 and the vehicle 105. For instance, the remote device 415 may monitor for an interaction from the user (e.g., operator or passenger of vehicle 105) to request for provision of the electrical power or transaction of items or services from the entity of the building 405. The request may correspond to a pre-pay order for the electrical energy to provide to the vehicle 105, as well as the items or services from the building 405. The request may be for a bundle of the electrical power and the items or services. Upon detection, the remote device 415 may provide the request along with information to the administrative device 410 (e.g., via a computer or cellular network).

Along with the request, the remote device 415 may send, transmit, or otherwise provide a target amount of electrical power to be delivered from the vehicle 105. The target amount of electrical power may be determined by the data acquirer circuitry 155 based on any number of factors, such as a remaining state of charge (SOC) in the battery pack 125, a remaining distance to the charge pad array 130, a location of a final destination of the vehicle 105, and a location of the vehicle 105, among others. The target amount may be part of a pre-order for the electrical power transmitted from the vehicle 105 to the administrative device 410.

The administrative device 410 may retrieve, identify, or receive a target amount of electrical power to be delivered from the vehicle 105. Using the target amount, the administrative device 410 may determine an estimated value (e.g., fee, cost, or rate) of the electrical power provided to the vehicle 105 for delivering the electrical power to the vehicle 105. The value may be based on a fee rate (e.g., set by administrative device 410), charging type, and an energy source (e.g., renewable or non-renewable) for each of the charge panels 145 within the charge pad array 130, among others. In some embodiments, the administrative device may identify the energy source for each charge pad 135 within the charge pad 135. The administrative device 410 may send, transmit, or otherwise provide the estimated value to the remote device 415. In some embodiments, the administrative device 410 may provide an identification of the energy source to the remote device 415.

The administrative device 410 may combine the value estimated for delivering electrical power from the charge pad array 130 with value for the requested items, services, or various operations within the building 405. The administrative device 410 may access a database to find values of the requested items or services. With the identification, the administrative device 410 may combine the value of the electrical power to be delivered with the values of the requested items or services. The combined value may correspond to or represent a bundle for the electrical charging with the items or services provided by the entity of the building 405. The administrative device 410 may provide the combined value to the remote device 415.

Upon receipt from the administrative device 410, the remote device 415 may present or display the values of the power to be delivered and the values of the items or services. In some embodiments, the remote device 415 may display the values of the power to be delivered and the values of the items or services via a user interface (e.g., of an application). The user may select accept or reject to complete the pre-order of the electrical power as well as the items and services. The remote device 415 may send an indication of acceptance (or rejection) to the administrative device 410. In some embodiments, the remote device 415 may also display the identification of the energy source of the electrical power for each charge pad 135. Upon presentation, the user may select which energy source to use to charge the vehicle 105. The remote device 415 may transmit the identification of selection of the energy source to the administrative device 410.

If the response indicates acceptance, the administrative device 410 may send, transmit, or otherwise provide a command signal to activate charging via the charge pads 135 of the charge pad 135. The administrative device 410 may also selectively activate the charge pads 135 based on the selection of energy source by the user. When the vehicle 105 moves over the charge pads 135, the charge panel 145 of the vehicle 105 may receive the electrical power from the charge pads 135 of the charge pad array 130. The charge panel 145 may transfer the electrical power to the other components 115 and/or to charge the battery pack 125. The vehicle 105 may be in motion or stationery, as the electrical power is received. If the response indicates rejection, the administrative device 410 may send, transmit, or otherwise provide a command signal to deactivate charging via the charge pads 135 of the charge pad 135.

In conjunction, the administrative device 410 may measure, determine, or otherwise identify an amount of electrical power transferred from the charge pad array 130 to the vehicle 105, as the vehicle 105 travels across the driving surface 110. For each charge pad 135 in the charge pad array 130, the administrative device 410 may also identify the amount of electrical power provided. Based on the measured amount of electrical power along with other factors (e.g., rate set by the administrative device 410), the administrative device 410 may calculate, generate, or otherwise determine an actual value (e.g., fee, cost, or rate) of the electrical power provided to the vehicle 105. The value may also be based on the speed of the vehicle 105 traveling over the charge pads 135 of the charge pad array 130. The administrative device 410 may provide the value to the remote device 415 for display.

The administrative device 410 may provide an output for the transaction of the items or sales, along with the delivery of the electrical power, to the remote device 4130. For example, the output may identify the actual value from the transaction at the point-of-sale device within the building 405, in addition to the actual value of the measure electrical power delivered to the vehicle 105. In some embodiments, the administrative device 410 may correlate the charging via the charge pad array 130 and a purchase order for an item or a service at the building 405 based on time stamps for the two events. With the correlation, the administrative device 410 may combine the value of the electrical power with values associated with the items or services provided by the entity of the building 405 to the remote device 415.

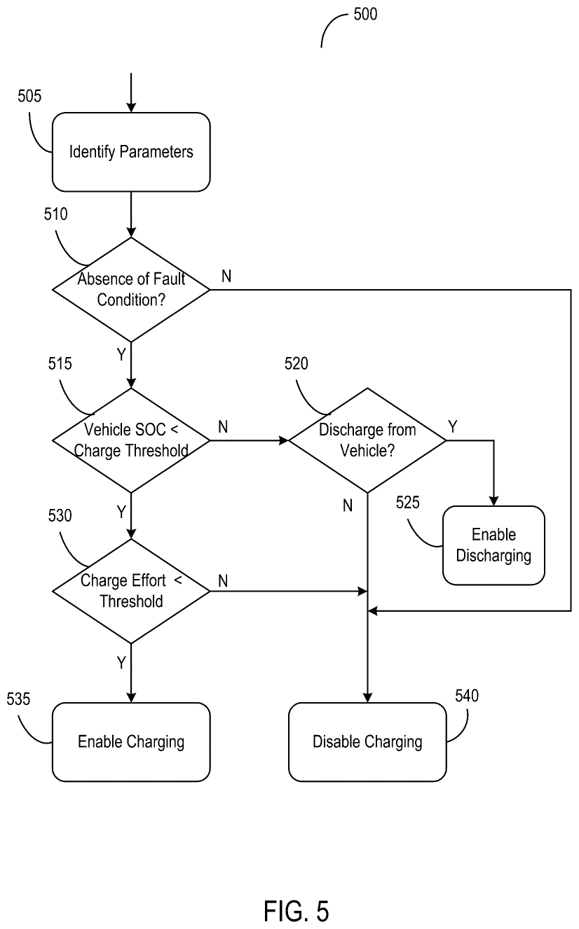

Referring now to FIG. 5, among others, depicted is a flow diagram of a method 500 of managing charge panels of vehicles to exchange electrical power. The method 500 may be implemented using or performed by any of the components described above, such as the vehicle 105, the charge pad array 130, and the charge management system 150, among others. Under the method 500, the data acquirer circuitry 155 executing on the charge management system 150 (or independently) may acquire, retrieve, or otherwise identify parameters (505). The data acquirer circuitry 155 may retrieve any fault code (or other fault indicator, or conditions indicative of an error or fault condition, or a combination thereof) for a charging system (e.g., the battery pack 125 or the charge panel 145) of the vehicle 105. The fault indicator may identify whether the charging system is operating properly and if not, which error is present (e.g., charge panel 145 disconnected). In addition, the data acquirer circuitry 155 may identify the state of charge (SOC) of the vehicle 105 by measuring the electrical power stored in the batteries of the battery pack 125. The data acquirer circuitry 155 may also acquire the set of characteristics of the charge pad array 130 as well as the operational parameters for the vehicle 105, as detailed herein above.

The panel manager circuitry 165 executing on the on the charge management system 150 (or independently) may determine whether a fault condition is present or absent (510). The fault condition may correspond to or identify whether the charging system (e.g., charge panel 145 or battery pack 125) in the vehicle 105 is operating properly. The panel manager circuitry 165 may determine whether the fault condition is present based on the presence of one or more fault codes (e.g., a predefined value that is triggered in response to a detected error, such as “FCXXX”). In the absence of a fault code or conditions indicating a possible malfunction or error condition (e.g., indicators of desired operation or proper functioning), the panel manager circuitry 165 may identify an absence of the fault condition in the vehicle 105. Otherwise, if the fault code corresponds to an error or improper functioning in the charging system, the panel manager circuitry 165 may identify a presence of the fault condition in the vehicle 105.

If the fault condition is determined to be absent, the panel manager circuitry 165 may determine whether the state of charge (SOC) of the vehicle 105 is below a predefined charge threshold (515). The state of charge may identify or correspond to an amount of electrical power remaining in the battery pack 125 of the vehicle 105 to provide power to the components 115 therein. The charge threshold may define a value for the SOC at which to initiate charging and accept electrical power via the charge panel 145. In some embodiments, the charge threshold may be a predetermined or predefined minimum value for the SOC of the vehicle 105. In some embodiments, the charge threshold may be calculated based on a remaining distance in the route, terrain, and other environmental conditions. With the determination, the panel manager circuitry 165 may compare the identified SOC of the vehicle 105 with the charge threshold. When the SOC is greater than or equal to the charge threshold, the panel manager circuitry 165 may determine to disable or deactivate charging via the charge panel 145. Conversely, when the SOC is less than the threshold, the panel manager circuitry 165 may determine to enable or activate charging via the charge panel 145.

If the SOC of the vehicle 105 is above the threshold, the panel manager circuitry 165 may determine whether to discharge from the vehicle 105 (the electrical energy storage devices, such as one or more of the batteries of the battery pack) via the charge panel 145 to provide the electrical power to the charge pad array 130 (or another power reserve) (520) (i.e., provide power back to the grid). The determination may be based on any number of factors, such as an amount of excess electrical power (e.g., amount of SOC above the threshold), a location of the vehicle 105, a location of the charge pad array 130, a terrain between the vehicle 105 and the charge pad array 130, a charge benefit value (e.g., sale value) for providing the electrical power to the charge array, the set of characteristics for the charge pad array 130, and the operational parameters of the vehicle 105, among others. For example, the panel manager circuitry 165 may receive data indicative of an upcoming downhill on the driving surface 110 with the charge pad array 130 buried therein. Rather than drawing power from the electrical power from the battery pack 125, the panel manager circuitry 165 may determine to discharge the electrical power back to the charge pad array 130 as the vehicle 105 travels across the driving surface 110 downhill.

When the determination is to discharge, the panel manager circuitry 165 may activate or enable discharging of the electrical power from the charge panel 145 to convey to the charge pad array 130 (525). The panel manager circuitry 165 may send, transmit, or otherwise provide a command signal to activate the charge panel 145 to provide the electrical power to the charge pad array 130. For example, the command signal may indicate a selling of the electrical power on the vehicle 105 back to the grid power system via the charge panel array 130. The panel manager circuitry 165 may command one or more motor-generators coupled to a moving component in the drive line (e.g., in the wheel, on the engine, flywheel, axle, or transmission) to go in a reverse mode to absorb torque from the wheel to generate electrical power. When the battery pack 125 is charged above a threshold amount, the charge panel 145 may transfer the electrical power from the motor-generator to the charge pad array 130. In some embodiments, the panel manager circuitry 165 may provide the command signal, upon determining that the vehicle 105 is within a threshold distance of the charge pad array 130. Once activated, the charge panel 145 may draw the electrical power from the battery pack 125 to deliver, convey, or otherwise provide to the charge pad array 130 (e.g., via inductive coupling).

If the SOC of the vehicle 105 is below the threshold, the panel manager circuitry 165 may determine whether a charge effort value is above a cost threshold (530). The charge effort value (sometimes herein referred to as cost of charging) may identify or correspond to a value representing charging via the charge panel 145 from the charge pad array 130. The cost of charging may in turn be based on the source of power that is provided to the charge pad array 130. The charge effort value may be determined using any number of factors, such as a fee from accepting the electrical power from the charge pad array 130, an environmental impact value (e.g., use of renewable or non-renewable power source, carbon credit, or total emissions), an opportunity cost, or health status of the vehicle 105, among others. The charge effort value may represent a holistic cost value from charging the vehicle 105 via the charge pad array 130. For instance, when a coal-fired plant is the source of electrical power for the charge pad array 130, the charge effort value may be higher to correspond to a higher environmental cost, relative to use of compressed natural gas (CNG) or propane.

The threshold may define a value for the cost effort at which to initiate charging and accept electrical power via the charge panel 145. The cost threshold may be predefined for the vehicle 105 (e.g., for specific vehicles), for a fleet that has the vehicle such that the threshold is the same for all vehicles in the fleet, and so on. For instance, the panel manager circuitry 165 may receive data indicative of an upcoming uphill on the driving surface 110 with the charge pad array 130 buried therein, with the determination that the SOC is below the threshold. In response, the panel manager circuitry 165 may determine that the charge effort value is below the threshold using other factors. The panel manager 15 may receive the electrical from the charge pad array 130 to charge the battery pack 125 as the vehicle 105 travels across the driving surface 110 uphill.

With the determination, the panel manager circuitry 165 may compare the charge effort value with the threshold. When the charge effort value is below the threshold, the panel manager circuitry 165 may determine to activate or enable charging via the charge panel 145. Conversely, when the charge effort value is above the threshold, the panel manager circuitry 165 may determine to deactivate or disable charging via the charge panel 145. In some embodiments, when the charge effort value is above the threshold, the panel manager circuitry 165 may compare the SOC with a critical threshold. The critical threshold may define or identify a value for the SOC at which to override the determination based on the charge effort value, and determine that the charging is to be activated. If the SOC is below the critical threshold and the charge effort value is above cost threshold, the panel manager circuitry 165 may determine to activate or enable charging. Otherwise, the panel manager circuitry 165 may determine to deactivate or disable charging.

If the charge effort value is below the threshold, the panel manager circuitry 165 may activate or enable charging (535). The panel manager circuitry 165 may send, transmit, or otherwise provide a command signal to the charge panel 145 to accept the electrical power from the charge pad array 130. In some embodiments, the panel manager circuitry 165 may provide the command signal, upon determining that the vehicle 105 is within a threshold distance of the charge pad array 130. Once activated, the charge panel 145 may draw the electrical power from the charge pad array 130 via the charge panel 145 (e.g., using inductive coupling). Upon receipt, the charge panel 145 may deliver, convey, or otherwise provide the electrical power to the components 115 or the battery pack 125 in the vehicle 105.

In some embodiments, the panel manager circuitry 165 may also communicate with the charge pad array 130, upon detecting the presence of the charge pad array 130 along the route of the vehicle 105. When the vehicle 105 is within a threshold distance of the charge pad array 130, the panel manager circuitry 165 may send, transmit, or provide an indication signal to the charge pad array 130 (or a computing system associated with the charge pad array 130). The command signal may be sent via vehicle-to-everything (V2X) communication protocol. The indication signal may indicate to the charge pad array 130 to activate the charge pads 135 to provide the electrical power to the vehicle 105 via the charge panel 145 (e.g., using inductive coupling). The provision of the electrical power may use a predetermined inductive charge for a target amount of electrical power.

In some embodiments, the panel manager circuitry 165 may monitor for charging efficiency of the charge panel 145 when inductively coupled with one or more of the charge pads 135 of the charge pad array 130. The charging efficiency may be measured as a function of the energy consumed by charging and the energy saved by the battery pack 125 or otherwise transferred from the charge panel 145. With the measurement, the panel manager circuitry 165 may compare the charging efficiency against a threshold. The threshold may define a value for the charging efficiency at which to provide an alert (e.g., audible or visual through the vehicle dashboard) to an operator of the vehicle 105. If the charging efficiency is above the threshold, the panel manager circuitry 165 may determine that the charging via the charge panel 145 is normal and may refrain from providing an alert. On the other hand, if the charging efficiency is below the threshold, the panel manager circuitry 165 may determine that the charging via the charge panel 145 is abnormal and may provide the alert. The alert may also identify an action for the operator of the vehicle 105 to take, such as clean the charge panel 145 or bring the vehicle 105 in for service.

In some embodiments, the panel manager circuitry 165 may determine whether to pull or draw the electrical power from an internal combustion engine or the charge panel 145 of the vehicle 105. The vehicle 105 may be a range-extended electric vehicle (REEV), and may be equipped with an internal energy source (e.g., internal combustion engine relying on fossil fuel or hydrogen or an electric-axle (e-axle) to produce electrical power from moving). The determination of whether to draw from the internal energy source or the charge panel 145 may be based on a number of factors, such as: the charge effort value (e.g., cost) for receiving power from the charge pad array 130, grid demand on the charge pad array 130, vehicle range, distance left on route for the vehicle 105, charger availability, charge type, the set of characteristics for the charge pad array 130, and the operational parameters of the vehicle 105, among others.

If the charge effort value is above threshold (or otherwise determine to deactivate), the panel manager circuitry 165 may deactivate or disable charging (540). In addition, the panel manager circuitry 165 may send, transmit, or otherwise provide a command signal to the charge panel 145 to deactivate the charge pad array 130 from accepting the electrical power from the charge pad array 130. The command signal may be sent via vehicle-to-everything (V2X) communication protocol The components 115 in the vehicle 105 may rely on or use the battery pack 125 within the vehicle 105 to draw the electrical power.

In some embodiments, the panel manager circuitry 165 (or another computing system) may perform a test (e.g., a production or service diagnostic test) on the charging system (e.g., the battery pack 125 or the charge panel 145) of the vehicle 105. The panel manager circuitry 165 may perform a test on the charge pads 135 of the charge pad array 130. The test on either the charging system in the vehicle 105 or the charge pad array 130 by using a predetermined inductive charge into the charging system of the vehicle 105 and measuring a voltage, current, or power produced via the charge panel 145 in the vehicle 105. The measurements may be used to determine the proper functioning of the charge system or the charge pad array 130. In some embodiments, the panel manager circuitry 165 may perform the test on each of the charge panels 145 (or the charge panel 305) in the vehicle 105, depending on the configuration of the charge panels 145. For instance, one test may be performed for the charge panel 145 when operating as a charge receiver and another test may be performed for the charge panel 145 when operating as a charge transmitter.

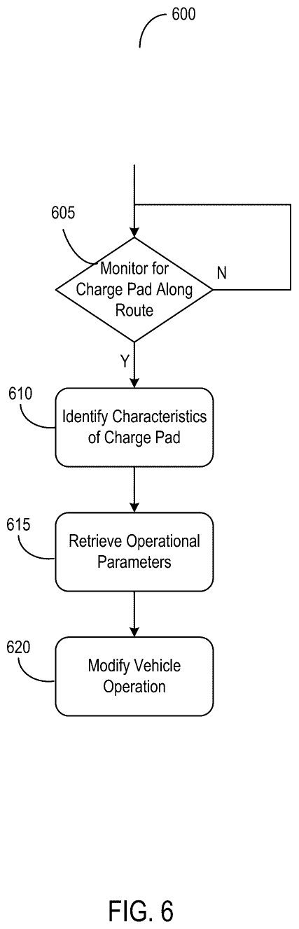

Referring now to FIG. 6, depicted is a flow diagram of a method 600 of modifying vehicle operations to charge electrical components. The method 600 may be implemented using or performed by any of the components described above, such as the vehicle 105, the charge pad array 130, and the charge management system 150, among others. In brief overview, under the method 600, a computing system may monitor for a charge pad along a route (605). The computing system may identify a set of characteristics of the charge pad (610). The computing system may retrieve a set of operational parameters of a vehicle (615). The computing system may modify a vehicle operation (620).

In further detail, a computing system (e.g., the controller 120) may check, identify, or otherwise monitor for a charge pad (e.g., charge pad 135) along a route of a vehicle (e.g., the vehicle 105) (605). The route may correspond to at least a portion of a driving surface (e.g., the driving surface 110). For example, the route may correspond to one of a set of lanes (e.g., the lanes 205) on the road along which the vehicle is traveling. The charge pad may be part of a set of charge pads in a charge pad array (e.g., the charge pad array 130). The computing system may be disposed in an electronic control unit (ECU) in the vehicle.

In some embodiments, the computing system may monitor for the charge pad using map data. The map data may define, identify, or otherwise include geographical or structural features (e.g., roads, highways, parking lots, buildings, rivers, mountains, and charge pads) in an environment in which the vehicle is traveling. Using the map data, the computing system may determine whether the charge pad exists within a set distance from the vehicle along the direction of travel. When the charge pad array exists, the computing system may detect the presence of the charge pad array. Otherwise, when the charge pad array does not exist, the computing system may determine that there is no charge pad array. When there is no charge pad array, the computing system may continue the operation of the vehicle.

In some embodiments, the computing system may monitor for the charge pad using data acquired via a sensor. The sensor may include, for example, a vehicle radar, Lidar, or camera, among others. The computing system may acquire the data via the sensor. With the acquisition, the computing system may compare the acquired data with data expected for a charge pad (e.g., signage indicating a location of a charge pad). When the data is determined to be for the charge pad, the computing system may detect the presence of the charge pad. Conversely, when the data is determined to be not for the charge pad, the computing system may detect an absence of the charge pad. When there is no charge pad array, the computing system may continue the operation of the vehicle.

In response to detecting the charge pad, the computing system may retrieve, receive, or otherwise identify a set of characteristics of the charge pad (610). The characteristics of the charge pad may identify or include, for example, charging locations (e.g., for individual charge pads), a charger type, a charge availability (or vacancy or occupation state), a charging power level (e.g., high-power or low-power), a charging rate (e.g., fast or slow rate), a charging cost, and a charging power source (e.g., non-renewable or fossil fuel), among others. In some embodiments, the computing system may identify the characteristics of the charge pad by communicating with a base station administering the charge pad array.

The computing system may identify, receive, or otherwise retrieve a set of operational parameters of the vehicle (615). The computing system may retrieve the set of operational parameters for the vehicle traveling on the route. The parameters for the vehicle may identify or include, for example, a state of charge (SOC) (e.g., of the battery pack 125), a battery age, a remaining range of the vehicle, a speed, a direction of travel, travel time, and a traffic status, among others. In some embodiments, the computing system may retrieve the set of operational parameters from other components on the vehicle. For example, the computing system may fetch the parameters related to the battery pack from an instrumentation device measuring the operational parameters of the battery pack.

The computing system may configure, change, or otherwise modify at least one operation of the vehicle (620). The modification may be in accordance with at least one of the set of characteristics of the charge pad or the set of operational parameters of the vehicle. The operations may include, for example, the route along which the vehicle is traveling, a speed of the vehicle, a position of the vehicle along the route, a charging system parameter of a charge panel (e.g., the charge panel 145), or a position of the charge panel, among others. The charging system parameters of the charge panel may include, for instance, a charging power (e.g., coil energizing), number of receiver plates (e.g., in the charge panel) activated or deactivated, and adjustment of air gap within the charge panels, among others. In some embodiments, the computing system may provide, present, or otherwise display information about the modification of the operation.

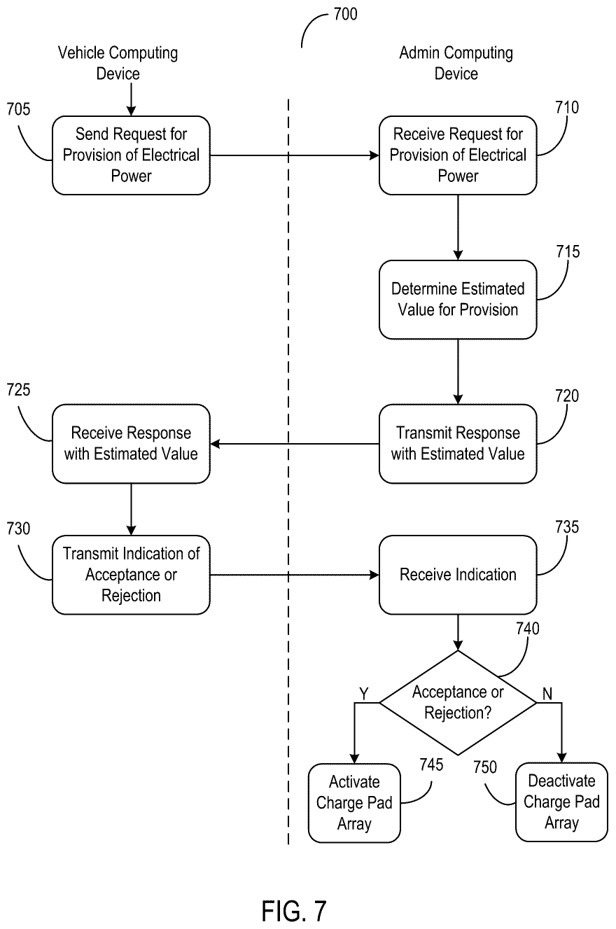

Referring now to FIG. 7, depicted is a flow diagram of a method 700 of providing electrical power from charging infrastructure. The method 700 may be implemented using or performed by any of the components described above, such as the vehicle 105, the charge pad array 130, the charge management system 150, the administrative device 410, or the remote device 415, among others. In brief overview, under the method 700, a vehicle computing device may send a request for provision of electrical power (705). An administrative computing device may receive the request for provision of electrical power (710). The administrative computing device may determine an estimated value for provision of electrical power (715). The administrative computing device may transmit a response with the estimated value (720). The vehicle computing device may receive the response with the estimated value (725). The vehicle computing device may transmit an indication of acceptance or rejection (730). The administrative computing device may receive the indication (735). The administrative computing device may determine whether the delivery is accepted or rejected (740). If accepted, the administrative computing device may activate a charge pad array (745). Otherwise, if not accepted, the administrative computing device may deactivate a charge pad array (750).

In further detail, a vehicle computing device (e.g., the controller 120 or the remote device 415) may provide, transmit, or otherwise send a request for provision of electrical power to an administrative computing device (e.g., the administrative device 410 or the base station 210) (705). The request may be for provision of electrical power from a charge pad array to a vehicle (e.g., the vehicle 105). The vehicle computing device may be disposed within the vehicle. In some embodiment, the administrative computing device may be disposed in a location (e.g., within the building 405) associated with management of the charging infrastructure.

The vehicle computing device may generate the request to include or identify a target amount of the electrical power to be provided to the vehicle from a charge pad array (e.g., the charge pad array 130). The target amount of the electrical power may be calculated or determined based on any number of factors related to the vehicle or a battery pack (e.g., the battery pack 125). In some embodiments, the vehicle computing device may generate the request to include or identify at least one transaction (e.g., an item or service) to be performed by an entity (e.g., the building 405) associated with the charge pad array. The request may include other information associated with the vehicle.

The administrative computing device may retrieve, identify, or otherwise receive the request for provision of electrical power from the vehicle computing device (710). Upon receipt of the request, the administrative computing device may process or parse the request to extract or identify the target amount of the electrical power to be provided to the vehicle. In some embodiments, the administrative computing device may parse the request to extract or identify the least one transaction to be performed from the request. In some embodiments, the administrative computing device may parse the request to extract or identify the information associated with the vehicle.

The administrative computing device may calculate, identify, or otherwise determine an estimated value for provision of electrical power based on the request (715). The administrative computing device may determine the estimated value (e.g., fee, cost, or rate) for delivering the electrical power to the vehicle using the target amount of the electrical power identified in the request. The target amount of the electrical power may be determined as a function of a fee rate, charging type, and an energy source for each of the charge pad within the charge pad array. In some embodiments, the administrative computing device may determine a value for the at least one transaction. The administrative computing device may access a database to find, retrieve, or otherwise identify the values of the requested items or services of the request. With the identification, the administrative computing device may determine a combined value using the estimated value for delivering the estimated value and the value for the transaction.

The administrative computing device may return, send, or otherwise transmit a response with the estimated value to the vehicle computing device (720). With the determination of the values, the administrative computing device may generate the response to include or identify the estimated value of the delivery of the electrical power to the vehicle. In some embodiments, the administrative computing device may generate the response to include information related to the delivery of the electrical power, such as the amount to be delivered, fee rate, charging type, and energy source, among others. In some embodiments, the administrative computing device may generate the response to include or identify the value of the transaction (e.g., for the item or service). In some embodiments, the administrative computing device may generate the response to include or identify the combined value.

The vehicle computing device may retrieve, identify, or otherwise receive the response with the estimated value (725). Upon receipt, the vehicle computing device may process or parse the response to extract or identify the estimated value, the value of the transaction, or the combined value, among others. With the identification, the vehicle computing device may provide, display, or otherwise present the information extracted from the response received from the administrative computing device. The information (e.g., the estimated value, the value of the transaction, or the combined value) may be presented via a user interface on a display (e.g., an on-board display or a display communicatively coupled with the vehicle computing device). The user interface may also include a selection for acceptance or rejection of the delivery of the electrical power or the transaction, or both.

The vehicle computing device may provide, send, or otherwise transmit an indication of acceptance or rejection (730). The vehicle computing device may monitor for an interaction with the user interaction to select on one of acceptance or rejection. When the selection is acceptance, the vehicle computing device may produce, output, or otherwise generate the indication of acceptance of the delivery of electrical power. The vehicle computing device may enable, turn on, or otherwise activate a charge panel to receive the delivery of the electrical power from the charge pad. In contrast, when the selection is rejection, the vehicle computing device may produce, output, or otherwise generate the indication of rejection of the delivery of electrical power. The vehicle computing device may also refrain from activating the charge panel to receive the delivery of the electrical power from the charge pad.

In some embodiments, the vehicle computing device may generate the indication of acceptance or rejection for the transaction. The indication may be separate from the indication for the delivery of electrical power. When the selection is acceptance, the vehicle computing device may produce, output, or otherwise generate the indication of acceptance of the transaction. In contrast, when the selection is rejection, the vehicle computing device may produce, output, or otherwise generate the indication of rejection of the transaction.

The administrative computing device may retrieve, identify, or otherwise receive the indication (735). The administrative computing device may process or parse the indication from the vehicle computing device. The administrative computing device may identify or determine whether the delivery of the electrical power is accepted or rejected (740). When the indication is to accept, the administrative computing device may determine that the delivery of the electrical power is accepted at the estimated value. When the indication is to reject, the administrative computing device may determine that the delivery of the electrical power is rejected at the estimated value.

If accepted, the administrative computing device may enable, turn on, or otherwise activate the charge pad array (745). The set of charge pads in the charge pad array are arranged in a curvature within a driving surface. As the vehicle drives across the charge pad array, each charge pad may provide the electrical power to the vehicle. Otherwise, if not accepted, the administrative computing device may disable, turn off, or otherwise deactivate the charge pad array (750). In some embodiments, the administrative computing device may refrain from activating the charge pad array.

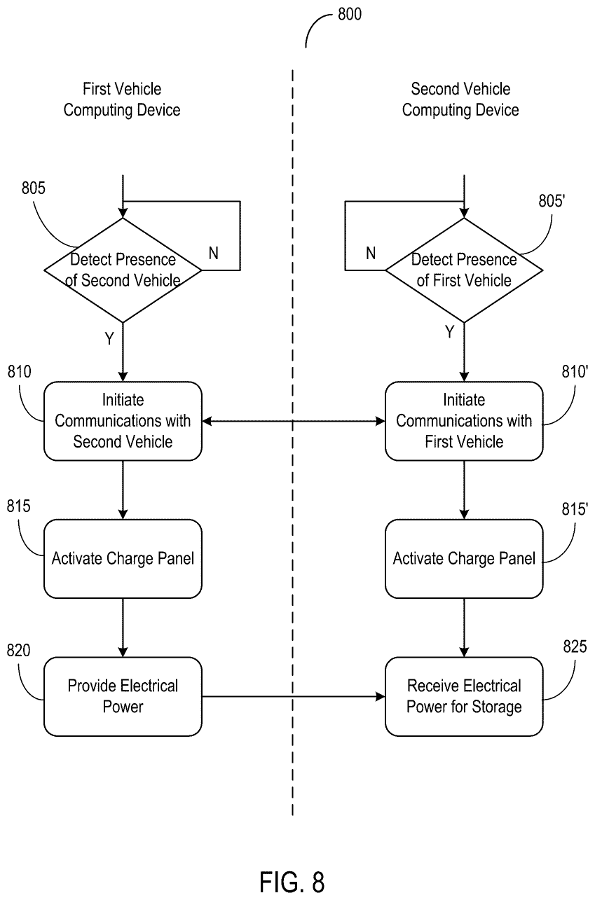

Referring now to FIG. 8, depicted is a flow diagram of a method 800 of exchanging electrical power among vehicles. The method 800 may be implemented using or performed by any of the components described above, such as the vehicle 105, the charge pad array 130, and the charge management system 150, among others. In brief overview, under the method 800, a computing device on a first vehicle may detect a presence of a second vehicle (805) and a computing device on a second vehicle may detect a presence of the first vehicle (805′). The computing device on the first vehicle may initiate communications with the second vehicle (810) and the computing device on the second vehicle may initiate communications with the first vehicle (810′). The computing device on the first vehicle may activate a charge panel (815) and the computing device on the second vehicle may activate a charge panel (815′). The computing device on the first vehicle may provide electrical power to the second vehicle (820). The second vehicle may receive the electrical power for storage (825).

In further detail, a computing device (e.g., the controller 120) on a first vehicle (e.g., the vehicle 105A) may monitor or check for a presence of a second vehicle (e.g., the vehicle 105B) (805). A computing device (e.g., the controller 120) on the second vehicle may monitor or check for a presence of the first vehicle (805′). To monitor, the computing device on each vehicle may check for the presence of the other vehicle using data acquired via a sensor. The sensor may include, for example, a vehicle radar, Lidar, or camera, among others. For instance, the data acquired by the sensor may be a Lidar measurement of objects about the vehicle. The computing device may use computer vision techniques (e.g., object detection, edge detection, or semantic segmentation) to recognize or detect the presence of the other vehicle (or other objects). If any of the detected objects correspond to a vehicle, the computing device may detect the presence of the other vehicle. In some embodiments, the computing device on each vehicle may monitor for the presence of the other vehicle using communications. For instance, the computing device may listen for signals (e.g., radiofrequency (RF) signals) transmitted by the other vehicle. Once the signal is detected, the computing device may detect the presence of the other vehicle.

In some embodiments, the computing device on at least one of the vehicles (e.g., the first vehicle) may check or monitor for the presence of a charge pad array (e.g., the charge pad array 130). The charge pad array may be disposed, arranged, or otherwise situated about the driving surface, upon which the vehicles may be present or traveling. To monitor, the computing device on each vehicle may check for the presence of the other vehicle using data acquired via a sensor. The sensor may include, for example, a vehicle radar, Lidar, or camera, among others. For instance, the data acquired by the sensor may be an image of signage along the highway corresponding to the route. If any of the detected image corresponds to the charge pad array, the computing device may detect the presence of the charge pad array. In some embodiments, the computing device on each vehicle may monitor for the presence of the charge pad array using communications. For instance, the computing device may listen for signals (e.g., radiofrequency (RF) signals) transmitted by the charge pad array. Once the signal is detected, the computing device may detect the presence of the charge pad array.

With the detection of the second vehicle, the computing device on the first vehicle may commence or initiate communications with the second vehicle (810). With the detection of the first vehicle, the computing device on the second vehicle may commence or initiate communications with the first vehicle (810′). The computing device on one vehicle may start communications with the computing device on the other vehicle in accordance with a communications protocol (e.g., vehicle-to-vehicle (V2V) communication protocol). The computing device on one vehicle may establish communications with the computing device on the other vehicle to coordinate transfer of charging. With the establishment, the computing device on the second vehicle may transmit, provide, or send a request to charge. The computing device on the first vehicle may retrieve, identify, or otherwise receive the request to charge.

In some embodiments, with the detection of the charge pad array, the computing device on the first vehicle may commence or initiate communications with the charge pad array or a base station (e.g., the base station 210) associated with the charge pad array. The computing device on one vehicle may start communications with the computing device on the other vehicle in accordance with a communications protocol (e.g., vehicle-to-everything (V2X) communication protocol). The computing device on one vehicle may establish communications with the charge pad array to coordinate transfer of charging. With the establishment, the computing device on the first vehicle may transmit, provide, or send a request to charge to the charge pad array (or the base station). The charge pad array (or the base station) may retrieve, identify, or otherwise receive the request to charge.

The computing device on the first vehicle may enable, turn on, or otherwise activate at least one charge panel (e.g., the charge panel 305) (815). The computing device on the second vehicle may enable, turn on, or otherwise activate the charge panel (e.g., the charge panel 305) (815′). With the exchanging of communications, the computing device on the first vehicle may coney, relay, or otherwise send a command signal to the charge panel to activate to provide electrical power to the second vehicle. Conversely, the computing device on the second vehicle may coney, relay, or otherwise send a command signal to the charge panel to activate to receive the electrical power from the first vehicle.

In some embodiments, with the exchanging of communications with the charge pad array, the computing device on the first vehicle may enable, turn on, or otherwise activate at least one charge panel. The charge panel for receiving electrical power from the charge pad array may be on an opposite side of the first vehicle from the side on which the charge pad array for providing electrical power to the second vehicle is situated. In some embodiments, the computing device on the first vehicle may activate the charge panel to receive the electrical power from the charge pad array, at least in partial concurrence with the activation of the charge panel to deliver the electrical power to the second vehicle. In this manner, the charge panels on the first vehicle may allow conveyance of electrical power from the charge pad array through the first vehicle to the second vehicle. In some embodiments, the computing device on the first vehicle may configure or cause the electrical power to be stored and maintained on the battery pack on the first vehicle.

The computing device on the first vehicle may transfer, convey, or otherwise provide electrical power to the second vehicle (820). The second vehicle may obtain, accept, or otherwise receive the electrical power for storage (825). With the activation, the computing device on the first vehicle may convey, relay, or otherwise send a command signal to the charge panel to convey, provide, or otherwise transfer the electrical power from a battery pack (e.g., the battery pack 125) to the second vehicle. Conversely, with the activation, the computing device on the second vehicle may convey, relay, or otherwise send a command signal to the charge panel to accept, receive, or otherwise obtain the electrical power from the first vehicle. Upon receipt, the computing system on the second vehicle may command the battery pack on the second vehicle to store the obtained electrical power.

For the purpose of this disclosure, the term “coupled” means the joining or linking of two members directly or indirectly to one another. Such joining may be stationary or moveable in nature. For example, a propeller shaft of an engine “coupled” to a transmission represents a moveable coupling. Such joining may be achieved with the two members or the two members and any additional intermediate members. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in the figures, it should be understood that the components may include any number of circuits for completing the functions described herein. For example, the activities and functionalities of the circuits of the charge management system 150 may be combined in multiple circuits or as a single circuit. Additional circuits with additional functionality may also be included. Further, the controller may further control other activity beyond the scope of the present disclosure.

As mentioned above and in one configuration, the “circuits” may be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Although the diagrams herein may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims. Such variations will depend on the machine-readable media and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system for modifying vehicle operations to charge electrical components, the system comprising
a computing system having one or more processors coupled with at least one memory, the computing system configured to:
detect a charge pad along a route of a vehicle, the vehicle comprising a charge panel configured to accept electrical power from the charge pad to provide to one or more electrical components in the vehicle;
identify, responsive to detection of the charge pad, a plurality of characteristics of the charge pad and a plurality of operational parameters of the vehicle; and
modify, in accordance with at least one of the plurality of characteristics of the charge pad or the plurality of operational parameters of the vehicle, at least one operation of the vehicle to receive the electrical power from the charge pad.

2. The system of claim 1, wherein the computing system is further configured to modify the route of the vehicle to be traveled based on the plurality of characteristics of the charge pad.

3. The system of claim 1, wherein the computing system is further configured to modify a speed of the vehicle along the route based on the plurality of characteristics of the charge pad.

4. The system of claim 1, wherein the computing system is further configured to modify an operation parameter of the charge panel based on a comparison between a current speed of the vehicle with a target speed for the charge pad.

5. The system of claim 1, wherein the computing system is further configured to modify a position of the charge panel to accept the electrical power from the charge pad along the route.

6. The system of claim 1, wherein the computing system is further configured to modify a vehicle position from a first lane to a second lane along the route to accept at least a portion of the electrical power from the charge pad.

7. The system of claim 1, wherein the computing system is further configured to detect the charge pad along the route of the vehicle using at least one of map data associated with the route or sensor data from at least one sensor of the vehicle.

8. The system of claim 1, wherein the computing system is further configured to cause, responsive to detecting the charge pad along the route of the vehicle, the vehicle to move in position based on at least one of the plurality of characteristics of the charge pad or the plurality of operational parameters of the vehicle.

9. The system of claim 1, wherein the computing system is further configured to maintain, responsive to detecting an absence of the charge pad along the route of the vehicle, the route along which the vehicle is traveling.

10. The system of claim 1, wherein the computing system is disposed in an electronic control unit (ECU) on the vehicle.

11. A method of modifying vehicle operations to charge electrical components, the method comprising
detecting, by a computing system, a charge pad along a route of a vehicle, the vehicle comprising a charge panel configured to accept electrical power from the charge pad to provide to one or more electrical components in the vehicle;
identifying, by the computing system, responsive to detection of the charge pad, a plurality of characteristics of the charge pad and a plurality of operational parameters of the vehicle; and
modifying, by the computing system, at least one operation of the vehicle to receive the electrical power from the charge pad in accordance with at least one of the plurality of characteristics of the charge pad or the plurality of operational parameters of the vehicle.

12. The method of claim 11, wherein modifying the at least one operation of the vehicle further comprises modifying the route of the vehicle to be traveled based on the plurality of characteristics of the charge pad.

13. The method of claim 11, wherein modifying the at least one operation of the vehicle further comprises modifying a speed of the vehicle along the route based on the plurality of characteristics of the charge pad.

14. The method of claim 11, wherein modifying the at least one operation of the vehicle further comprises modifying an operation parameter of the charge panel based on a comparison between a current speed of the vehicle with a target speed for the charge pad.

15. A vehicle, comprising:
a charge panel structured to be electrically coupled with one or more electrical components; and
a controller coupled to the charge panel, the controller having one or more processors coupled with at least one memory, the controller configured to:
detect, along a route of the vehicle, a charge pad from which to accept electrical power to provide to the one or more electrical components via the charge panel;
identify, responsive to detection of the charge pad, a plurality of characteristics of the charge pad and a plurality of operational parameters of the vehicle; and
modify, in accordance with at least one of the plurality of characteristics of the charge pad or the plurality of operational parameters of the vehicle, at least one operation of the vehicle to receive the electrical power from the charge pad.

16. The vehicle of claim 15, wherein the controller is further configured to modify a speed of the vehicle along the route based on the plurality of characteristics of the charge pad

17. The vehicle of claim 15, wherein the controller is further configured to cause, responsive to detecting the charge pad along the route of the vehicle, the vehicle to move in position based on at least one of the plurality of characteristics of the charge pad or the plurality of operational parameters of the vehicle.

18. The vehicle of claim 15, wherein the controller is further configured to detect the charge pad along the route of the vehicle using at least one of map data associated with the route or sensor data from at least one sensor of the vehicle.

19. The vehicle of claim 15, wherein the controller is further configured to modify a vehicle position from a first lane to a second lane along the route to accept at least a portion of the electrical power from the charge pad.

20. The vehicle of claim 15, wherein the controller is further configured to modify an operation parameter of the charge panel based on a comparison between a current speed of the vehicle with a target speed for the charge pad.
